(19) United States
(12) Patent Application Publication
(10) Pub. No.: US 2004/0026840 A1
(43) Pub. Date: Feb. 12, 2004

(54) Torsion spring set

(76) Inventors: Hans-Gerd Eckel, Laudenbach (DE); Volker Hirsch, Speyer (DE); Erhard Moog, Gorxheimertal (DE); Anja Kunkel, Waldmichelbach (DE)

Correspondence Address: KENYON & KENYON, ONE BROADWAY, NEW YORK, NY, 10004, US

(21) Appl. No.: 10/380,976

(22) PCT Filed: Sep. 27, 2001
(86) PCT No.: PCT/EP01/11200

(30) Foreign Application Priority Data
Sep. 27, 2000 (DE) 100-49-001.8

(51) Int. Cl. F16F 1/14

(52) U.S. Cl. 267/154

(57) ABSTRACT

The present invention relates to a torsion spring set especially for the powertrain system of a motor vehicle, having a first internally located component (1) and a second externally located component (2) situated in such a way that it may be rotated in relation thereto, and having a spring (3) acting between the first and second component (1, 2) embodied in the form of a torsion spring, and also having a first securing device (7) for connecting a first end section (9) of the spring (3) to the first component (1) and a second securing device (8) for connecting a second end section (10) of the spring (3) to the second component (2). The spring (3) extends essentially in the direction of the periphery over at least one part of the periphery of the first component (1). At least one of the securing devices (7, 8) is embodied in such a way that the first and/or second end sections (9, 10) is/are moved in a radial direction to the second component (2) when the first component (1) is rotated.

### FIELD OF THE INVENTION

The present invention relates to a torsion spring set. More particularly, the present invention relates to a torsion spring set for the powertrain system of a motor vehicle.

### BACKGROUND INFORMATION

Internal combustion engines used in motor vehicles produce a torque at the crankshaft, whose pattern over time is not constant. Dynamic components are superimposed on the average momentum of the engine, which leads to a nonuniform rotation of the crankshaft and of the components connected to it. This causes vibrations to be created in the powertrain system which may impair the riding comfort of the motor vehicle. An efficient method for reducing the transmission of rotary vibrations from the crankshaft to the powertrain system is the vibrational decoupling of the crankshaft and the powertrain system. Torsion spring sets are known which may be applied to the vibrational decoupling of the powertrain system in motor vehicles. For this purpose, a second rotating mass is typically linked to the flywheel of the crankshaft via a relatively soft torsion spring. While the flywheel follows the nonuniform rotation of the crankshaft, the speed fluctuations, of the second rotating mass, which is connected to the transmission via a clutch, turn out to be significantly lower. In this manner, the powertrain system may be stabilized.

The central element of the torsion spring set is the torsion spring between the two rotating masses. On the one hand, it is desired that the torsion spring be yielding enough to sufficiently decouple the vibrations of the crankshaft. On the other hand, it is also desirable that sufficient spring travel be available to absorb the static torque of the engine, and at the same time also permit the relative motions between the two rotating masses caused by the crankshaft vibrations.

One example of a torsion spring is described in German Patent Publication No. DE 40 06 121 A1, in which a spring is configured as a spiral spring which extends in several windings about the first inner component. In this case, the spring is accommodated in a space limited by an external contour and an internal contour. The external contour and the internal contour are situated concentrically to the axis of rotation. The disadvantage of this set-up is that it requires a large installation space. Thus, a power density of the spring is not sufficient in all cases. The power density of the spring is defined as a ratio of the torque which may be transmitted by the spring, while maintaining a required stiffness, to the space required by the spring.

### SUMMARY OF THE INVENTION

One objective of the present invention is to provide a torsion spring set which requires only a small space.

According to one embodiment of the present invention, there is provided a torsion spring set for the powertrain system of a motor vehicle. The torsion spring set has a first internally located component, and a second externally located component situated in such a way that it may be rotated in relation thereto. The torsion spring set also has a spring acting between the first and second component, embodied in the form of a torsion spring. The torsion spring set also has a first securing device for connecting a first end section to the first component and a second securing device for connecting a second end section of the spring to the second component. The spring extends essentially in the direction of the periphery over at least one part of the periphery of the first component.

According to one embodiment of the present invention, the above-stated objective is satisfied whereby the torsion spring set has at least one securing device configured such that the first and/or second end section is moved in the radial direction when the first component is twisted relative to the second component.

According to one embodiment of the present invention, a uniform bending stress of the spring over its entire length is enabled, thereby providing a better utilization of the spring, and thus a greater power density. In one embodiment, one end section of the spring is fixedly connected to the first and second component, while the other end section is configured to be movable.

According to one advantageous embodiment of the present invention, the spring is accommodated in an installation space which is limited by an external contour and an internal contour, such that the maximum torsion angle between the first and second component is limited by the spring lying adjacent to the external and the internal contour. In this embodiment, the external contour may be formed by the inner surface of the second component, and the internal contour may be formed by the outer surface of the first component. The external contour and the internal contour are formed in such a way that they limit the deformation of the spring, thereby limiting not only the torsion angle between the first and the second component but also the mechanical stress of the spring element. The spring lies adjacent to the internal contour in particular with its full surface during spring compression, whereas during rebound the spring lies adjacent to the external contour in particular with its full surface.

According to another embodiment of the present invention, the external contour and/or the internal contour of the installation space are formed as a circular arc. By using the circular design, a uniform deformation and stress develops when the spring, particularly likewise extending over a circular arc, having a constant spring cross section, lies adjacent to the external contour or the internal contour.

Additional power density of the torsion spring set is provided by positioning the external contour and/or the internal contour offset to each other. In this connection, in the embodiment wherein the external contour and the internal contour are formed as circular arcs, the center points of the circular arcs are at a distance from each other. During compression of the spring, the external contour and the internal contour are twisted relative to each other about the common axis of rotation of the first and the second component. In this respect, the center points of the circular arcs are positioned at a distance from the axis of rotation.

According to still another embodiment, upon compression of the spring up to the point of its lying adjacent to the internal contour, the center point of the internal contour lies on, or in the vicinity of, a straight line through a center of the fixedly clamped end section. Here, the center point of the internal contour lies between the axis of rotation and the firmly clamped end section.

Furthermore, according to the present invention, the torsion spring set may be configured in such a way that, upon rebounding of the spring up to the point of its lying adjacent to the external contour, the center point of the external contour lies on, or in the vicinity of, a straight line through the axis of rotation and the center of the fixedly clamped end section. In this embodiment the center point of the external contour lies on the section of the straight line which lies on the other side of the axis of rotation, on the side facing away from the firmly clamped end section.

According to still another embodiment of the present invention, at least one of the securing devices is formed in such a way that the first and/or second end section is twisted about a point of rotation when the first component is twisted relative to the second component. Twisting, in this context, is defined as a rotation about a point of rotation which is different from the axis of rotation. In this manner, a radial motion and a rotational motion of the end section of the spring are achieved. Thereby the stress of the spring in the vicinity of the end section may be further reduced.

According to another embodiment of the present invention, at least one securing device has a first securing section on the spring side, which cooperates with a second securing section of the first or second component. This achieves a construction that is especially simple to manufacture and install. In this manner, the first and second securing section may be connected to each other by form positive locking.

According to still another embodiment of the present invention, the first securing section is configured as a securing flange having a tip. The first and second securing section are configured such that the securing flange is rotated about its tip when the first component is twisted relative to the second component. In this way, the end section of the spring is reliably fixed. At the same time, because of the rotation of the securing flange, a radial displacement about the spring's tip and a twisting of the end section of the spring may occur.

According to a further embodiment of the present invention, the spring extends by an angle of less than 360° about the first component. Thus, the individual spring is not wound manifold about the first component. The angle reading, in this case, refers only to the effective spring length.

According to one embodiment of the present invention, a static imbalance of the torsion spring may be avoided by the torsion spring having at least one spring combination of a number n of springs, the springs being inserted in parallel next to one another, and each offset by an angle of 360°/n. Here, n is greater than or equal to 2.

With regard to imbalances that may occur, a further improvement is achieved by providing two spring combinations, and by positioning them in mirror-image symmetry relative to a plane that is perpendicular to the axis of rotation. Thus, if each spring combination has two springs, altogether four springs are provided inserted in parallel, and are positioned next to one another with respect to the axis of rotation in the axial direction. The two outer springs are situated the same way, in their rotational position. However, the inner-lying springs are both twisted with respect to the outer springs by 180°. In this connection, the spring combination positioned further to the left is situated in mirror-image symmetry to the spring combination situated further to the right, the plane of symmetry running in the middle between the two spring combinations. In this manner, the inner-lying springs are both twisted with respect to the outer springs by 180°. This set-up provides the advantage that the center of gravity of the spring package and of the first and second components lie on the axis of rotation with the internal contour and the external contour. Thus, a static and/or dynamic imbalance may be avoided when there is a rotation of the parts. This advantage may also be achieved with different numbers of springs, e.g., by combining the two inner-lying springs in each case to a single spring having double the width. Advantageously, the springs and the first and second components are situated symmetrically with respect to a plane through the axis of rotation, and the common center of gravity of all springs lies on the axis of rotation.

### BRIEF DESCRIPTION OF THE DRAWINGS

An exemplary embodiment is explained below with the aid of the drawings. The figures show:

FIG. 1 illustrates a cross section through a torsion spring set, in a rest position, according to one embodiment of the present invention;

FIG. 2 illustrates a cross section through the torsion spring set shown in FIG. 1, in a first stop position;

FIG. 3 illustrates a cross section through the torsion spring set shown in FIG. 1, in a second stop position;

FIG. 4 illustrates a longitudinal section through a torsion spring set, according to another embodiment of the present invention; and

FIG. 5 illustrates a cross section through the torsion spring set shown in FIG. 4.

### DETAILED DESCRIPTION

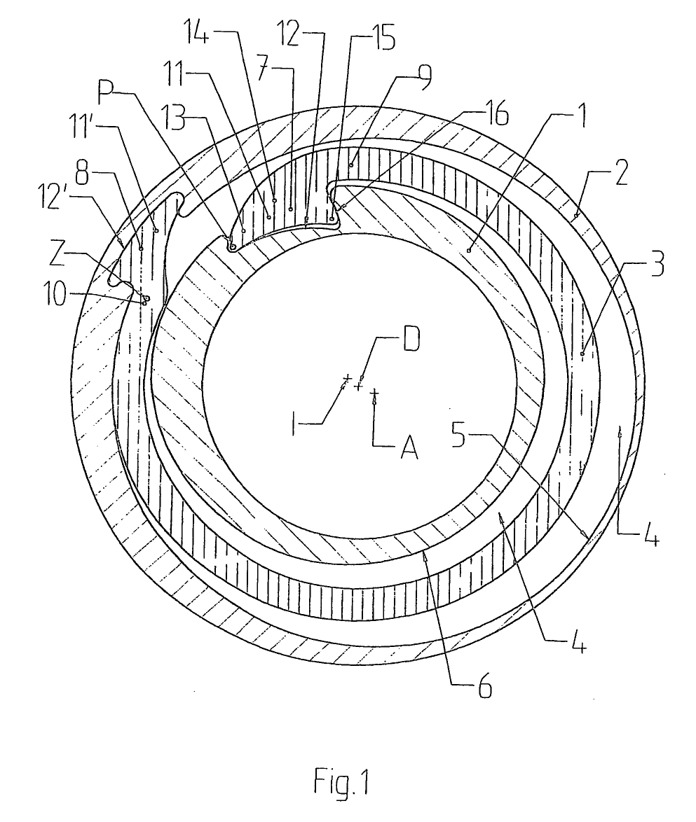

FIGS. 1 through 3 illustrate a torsion spring set for the powertrain system of a motor vehicle. The torsion spring set has a first, internally located component 1, and a second externally located component 2. In this context, first component 1 may be connected to the flywheel of a motor vehicle engine, and second component 2 may be connected to the transmission via a clutch, such a connection being made in a known manner, and accordingly not being shown in the Figures. First internally located component 1 is configured as a hollow piece which is completely enclosed at a distance by second component 2. First and second components 1, 2 may rotate about an axis of rotation D, and are positioned to be able to twist with respect to each other.

A torsion spring 3 acts between first and second components 1, 2, and is accommodated in the installation space formed between first component 1 and second component 2. Installation space 4 is limited in the radial direction by an external contour 5 and an internal contour 6. In this embodiment, the external contour 5 may be formed by the inner surface of the second component 2, and the internal contour 6 may be formed by the outer surface of the first component 1.

Furthermore, a first securing device 7 is provided for connecting a first end section 9 of spring 3 to first component 1. In addition, a second securing device 8 is provided for connecting second end section 10 of spring 3 to second component 2. In this manner, spring 3 extends between first and second end sections 9 and 10, essentially in the circumferential direction, over a part of the periphery of first component 1.

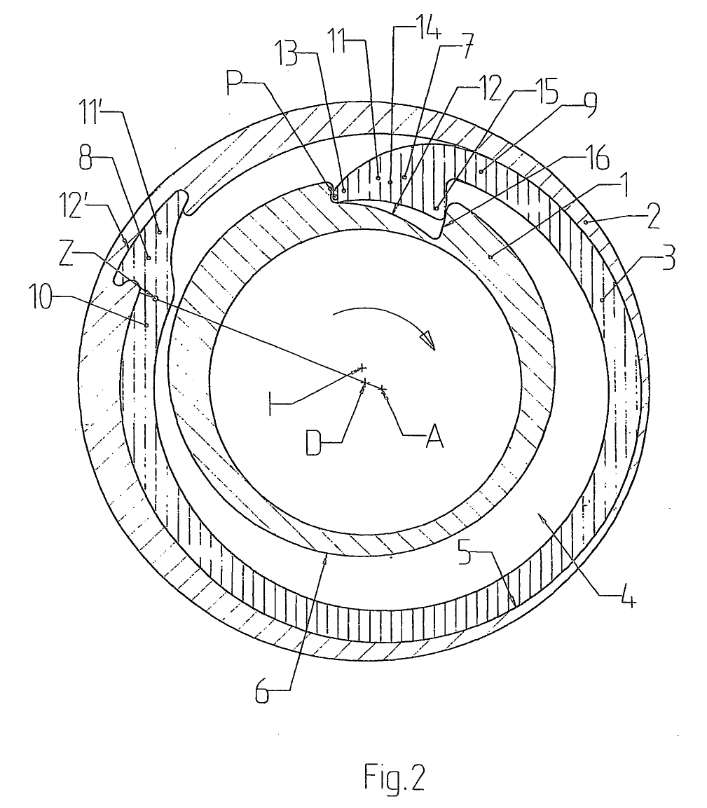

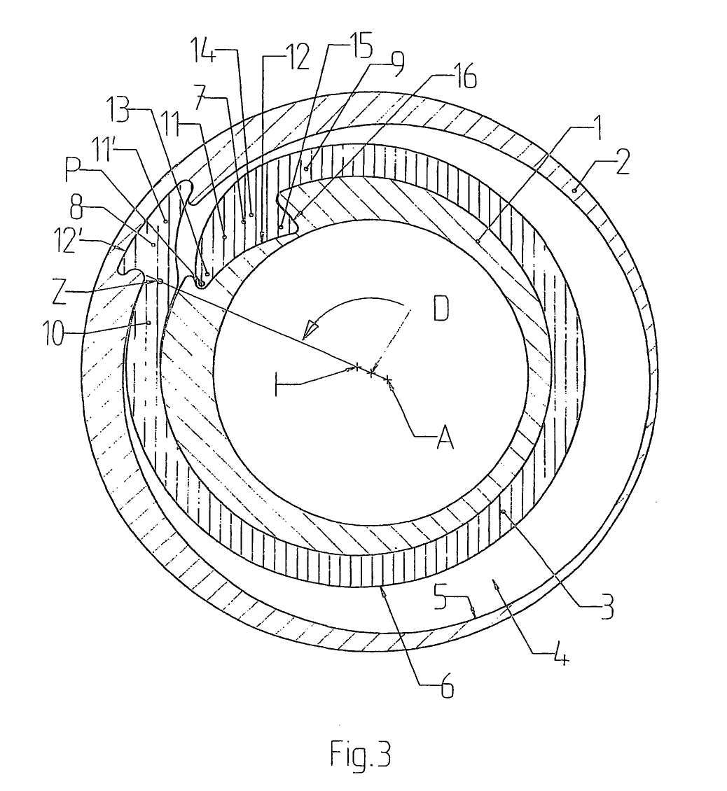

As may be seen in FIGS. 2 and 3, the maximum torsion angle between first and second components 1, 2 is limited by the seating of spring 3 on external contour 5 and internal contour 6. In FIG. 2, spring 3 is shown in its bent-open state, by lying adjacent over its full surface to external contour 5. In FIG. 3, spring 3 is shown in its bent-shut state, by lying adjacent over its full surface to internal contour 6. External contour 5 and internal contour 6 of installation space 4 are each developed as circular arcs extending over nearly the entire periphery. In this connection, external contour 5 and internal contour 6 are situated so as to be offset relative to each other, such that center point A of external contour 5 and center point I of internal contour 6 are at a distance from each other. The height of installation space 4 in the radial direction varies over the periphery. In the region of second securing device 8 the distance apart is relatively small, while in the opposite section of installation space 4 it is relatively large.

In this embodiment, the torsion spring set is configured such that, when spring 3 is compressed until it lies adjacent to internal contour 6, center point I of internal contour 6 lies on, or in the vicinity of, a straight line which runs through axis of rotation D and a center Z of firmly clamped end section 10 (of FIG. 3). Here, center point I of the internal contour 6 lies between axis of rotation D and firmly clamped end section 10. When the spring rebounds to the point where it lies adjacent to external contour 5, center point A of external contour 5 lies on, or in the vicinity of, a straight line through axis of rotation D and center Z of firmly clamped second end section 10. In this context, center point A of external contour 5 lies on the section of the straight line which lies on the other side of axis of rotation D, on the side facing away from firmly clamped end section 10.

In the embodiment shown, first and second securing devices 7, 8 are configured such that each have a first securing section 11, 11′ on the spring side, which cooperate with a second securing section 12, 12′ of the first or second component 1, 2. In this case, first and second securing sections 11, 11′ and 12, 12′ are connected to one another by form locking.

First and second securing section 11′, 12′ are connected at second securing device 8 in such a way that second end section 10 is fixed with respect to second component 2 in the axial and the radial direction. This is accomplished by having first securing section 11′, which is designed as a securing flange, connected in the circumferential direction on both sides by form locking to securing section 12′.

First securing device 7, on the other hand, is configured so that first and/or second end section 9, 10 of spring 3 is moved relative to second component 2 in the radial direction, when first component 1 is twisted. However, in the embodiment shown in the Figures, there is not only a motion in the radial direction, but also a twisting of first end section 9 relative to first component 1 about a point of rotation P.

In this embodiment, first securing section 7, 8 is configured as a securing flange 14 having a tip 13. First and second securing section 11, 12 are configured such that securing flange 14 is rotated about its tip 13 when first component 1 is twisted relative to second component 2. In order to ease the rotation, tip 13 of securing flange 14 is provided with a radius which, in the manner of a hinged joint, is housed in a recess of securing section 11 in first component 1.

In this embodiment, first and second securing section 7, 8 are configured such that spring 3, and particularly first end section 9, may hug external contour 5 (of FIG. 2) when spring 3 is bent apart, and, may completely hug internal contour 6 of first component 1 when spring 3 is bent together. As the spring 3 moves from the bent-apart position to the bent-together position, securing flange 14 executes a rotating motion about point of rotation P. Rear section 15 of securing flange 14 is formed so that it lies adjacent, and with little play, to a holding section 16 of first securing device 7. Thus, a transmission of forces in both directions of rotation, that is nearly free from play, is made possible. In this embodiment, rear section 15 of securing flange 14 and holding section 16 have a contour which is formed by a circular arc about point of rotation P.

The arc of spring 3 between first end section 9 and second end section has a value less than 360°. In order to achieve additional viscous damping and lubrication of the torsion spring set, a fluid may be accommodated in installation space. In this embodiment, the redistribution of the fluid is achieved automatically by the local, radial shifting of the spring elements.

Whereas first component 1 and second component 2 are essentially rigid bodies made of steel, spring 3 is advantageously configured as an elastic component, which according to one embodiment, may be made of steel also.

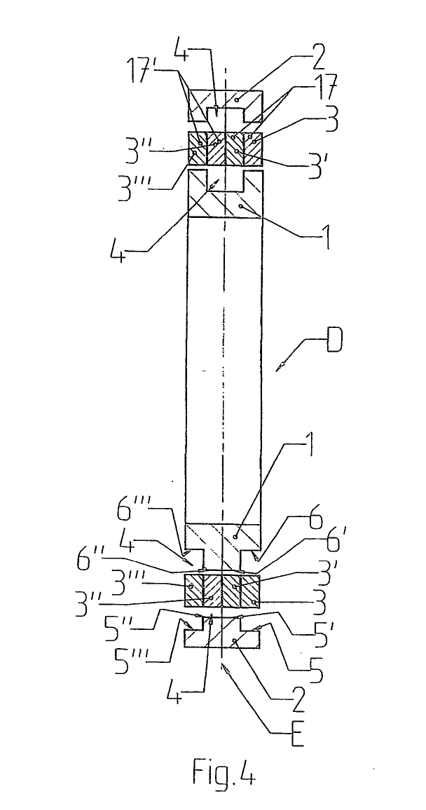

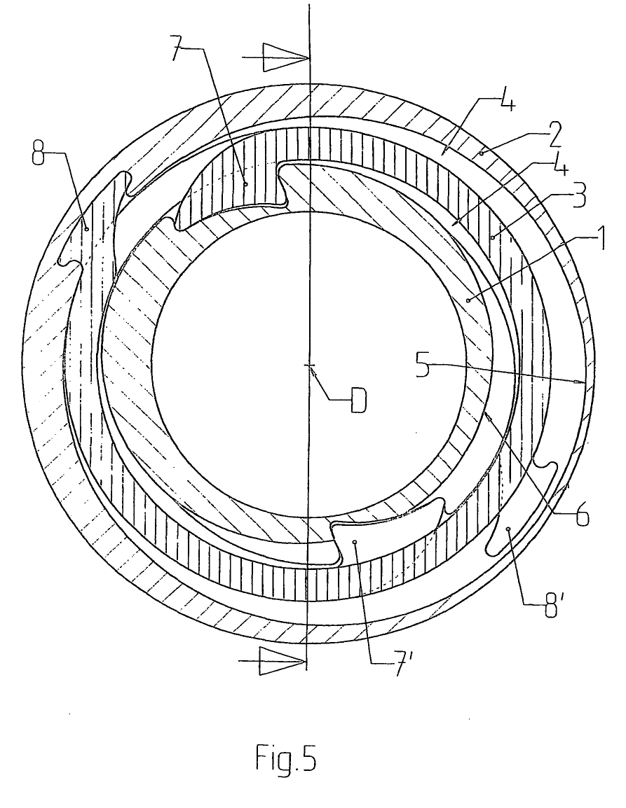

In FIGS. 4 and 5, those parts having the same function as parts shown in FIGS. 1 to 3 are provided with the same reference symbols. In the embodiments shown in FIGS. 4 and 5, four springs 3, 3′, 3″, 3′″ are provided. In this embodiment, springs 3 and 3′ form a spring combination 17 of two springs. Springs 3 and 3′ are inserted parallel situated next to each other and positioned to be offset by an angle of 180° about axis of rotation D. Along with springs 3 or 3′, external contours 5 or 5′ and internal contours 6 or 6′ are also positioned rotated by 180°. Correspondingly, at first component 1 as well as at second component 2 a step-shaped cross section is illustrated.

A comparable spring combination 17′ is situated next to spring combination 17, as a mirror image to a plane E, which runs perpendicularly to axis of rotation D. Thus, the specific embodiment of the present invention, shown in FIGS. 4 and 5, altogether has four springs 3, 3′, 3″, 3′″, which are situated next to one another in the axial direction with respect to axis of rotation D. The two outer springs 3 and 3′″ are situated the same way, in their rotatory position. On the other hand, inner-lying springs 3′, 3″ are both rotated with respect to outer springs 3, 3′″ by 180° about axis of rotation D. The common center of gravity of all the springs thereby lies on axis of rotation D.

FIG. 5 illustrates a cross-sectional view of the torsion spring set illustrated in FIG. 4. Here it is shown that spring 3, shown in cross section, and spring 3′ lying behind it, whose position is shown partially hatched, are positioned so as to be rotated by 180° relative to each other.

15. (New) A torsion spring set comprising:
a first internally located component;
a second, externally located component rotationally situated relative to the first component;
a torsion spring acting between the first and the second component;
a first securing device for connecting a first end section of the spring to the first component; and
a second securing device for connecting a second end section of the spring to the second component, the spring peripherally extending over at least one part of a periphery of the first component, wherein at least one of securing devices is configured so that at least one of the first and the second end section is moved in a radial direction when the first component is twisted relative to the second component.

16. (New) The torsion spring set as recited in claim 15, wherein the spring is housed in an installation space which is limited by an external contour and an internal contour and wherein the spring lies adjacent to the external contour and to the internal contour so as to limit a maximum torsion angle between the first and the second component.

17. (New) The torsion spring set as recited in claim 16, wherein at least one of the external contour and the internal contour of the installation space are configured as circular arcs.

18. (New) The torsion spring set as recited in claim 16, wherein the external contour and the internal contour are positioned so as to be offset relative to each other.

19. (New) The torsion spring set as recited in claim 17, wherein a center point of the circular arcs of the external contour and the internal contour are located at a distance from each other.

20. (New) The torsion spring set as recited in claim 19, wherein, when the spring is compressed until it lies adjacent to the internal contour, the center point of the internal contour one of lies on and lies in the vicinity of a straight line through an axis of rotation and a center of a firmly clamped end section.

21. (New) The torsion spring set as recited in claim 19, wherein, when the spring is positioned such that the spring lies adjacent to the external contour, a center point of the external contour one of lie on and lies in the vicinity of a straight line through an axis of rotation and a center of the firmly clamped end section.

22. (New) The torsion spring set as recited in claim 15, wherein, when the first component is twisted relative to the second component, at least one of the securing devices is configured so that at least one of the first and the second end sections is rotated about a point of rotation.

23. (New) The torsion spring set as recited in claim 15, wherein at least one securing device has a first securing section on a spring side, which cooperates with a second securing section of one of the first and the second components.

24. (New) The torsion spring set as recited in claim 9, wherein the first and the second securing sections are connected to one another by form locking.

25. (New) The torsion spring set as recited in claim 23, wherein the first securing section is configured as a securing flange having a tip, and wherein the first and the second securing section are configured such that the securing flange is rotated about its tip when the first component is twisted relative to the second component.

26. (New) The torsion spring set as recited in claim 15, wherein the spring extends about the first component by an angle of less than 360°.

27. (New) The torsion spring set as recited in claim 15, wherein at least one spring combination of a number n of springs is provided, the springs being positioned parallel next to one another and offset in each case by an angle of 360°/n.
